(19) United States
(12) Patent Application Publication
(10) Pub. No.: US 2009/0027659 A1
(43) Pub. Date: Jan. 29, 2009

(54) Measuring system for measuring a physical parameter influencing a sensor element

(75) Inventors: Nevio Vidovic, Goteborg (SE); Martin Dahlgren, Goteborg (SE); Svante Hojer, Kungalv (SE)

Correspondence Address: BUCHANAN, INGERSOLL & ROONEY PC, POST OFFICE BOX 1404, ALEXANDRIA, VA, 22313-1404, US

(73) Assignee: Sambra Sensors AB, Vastra Frolunda (SE)

(21) Appl. No.: 12/155,936

(22) Filed: Jun. 11, 2008

Related U.S. Application Data
(63) Continuation-in-part of application No. 11/175,171, filed on Jul. 7, 2005, now abandoned.
Application No. 11/175,171 is a division of application No. 10/018,220, filed on Apr. 26, 2002, now Pat. No. 6,934,015.

(30) Foreign Application Priority Data
Jun. 18, 1999 (SE) 9902320-2

(51) Int. Cl. G01N 21/25

(52) U.S. Cl. 356/73.1

(57) ABSTRACT

A measuring system is disclosed for measuring a physical parameter influencing a sensor element adapted to be connected to a measuring and control unit. The system comprises an information-carrying unit comprising a memory and being adapted to be associated with said measuring and control unit, said information-carrying unit being coordinated with the sensor element by containing stored information regarding the properties of the measuring system and the sensor element during measurements, and said information-carrying unit being supported by a connector for connecting said sensor element with said measuring and control unit.

### RELATED APPLICATIONS

This application is a Continuation-In-Part application of U.S. patent application Ser. No. 11/175,171, filed in US on Jul. 7, 2005; which is a Divisional Application of U.S. patent application Ser. No. 10/018,220, filed in US on Apr. 26, 2002, and issued as U.S. Pat. No. 6,934,015 on Aug. 23, 2005; which is a national stage of PCT/SE00/01296 having an international filing date of Jun. 16, 2000, and claiming priority under 35 U.S.C. §119 to Swedish application 9902320-2, filed in Sweden on Jun. 18, 1999.

### TECHNICAL FIELD

The present disclosure relates to measuring systems. For example, the disclosure relates to a measuring system for measuring a physical parameter influencing a sensor element adapted to be connected to a measuring and control unit.

### BACKGROUND ART

In connection with measuring physical parameters such as pressure and temperature, it is previously known to utilise various sensor systems by which the optical intensity of a ray of light, conveyed through an optical fiber and coming in towards a sensor element, is influenced due to changes in the respective physical parameter. Such a system may for example be used when measuring the blood pressure in the veins of the human body. Said system is based upon a transformation from pressure to a mechanical movement, which in turn is transformed into an optical intensity, conveyed by an optical fiber, which is in turn transformed into an electrical signal that is related to the measured pressure.

According to known art, such a fiber-optical measurement system may comprise a pressure sensor, an optical fiber connected to said pressure sensor, and at least one light source and at least one light detector located at the opposite end of the fiber, in order to provide the pressure sensor with light, and to detect the information-carrying light signal returning from the pressure sensor, respectively.

One problem occurring with previously known systems of the above kind relates to the fact that interference may occur in the signal transmission path, for example caused by fiber couplings or through bending, intentionally or unintentionally, of the fiber. Already at a light deflection of the fiber, a reduction of the light signal occurs. This signal damping, caused by the bent fiber, entails that the light signal detected in the light detector, which is related to the pressure detected in the sensor element, will have a value that does not coincide with the real pressure. The size of the deviation will then depend on how much the fiber was deflected.

Through EP 0 528 657 A2 a fiber-optical measurement system for measuring pressure is known. Said system comprises a pressure sensor with a membrane, three LED:s emitting light at different wavelengths, and two photo detectors. The system is arranged so that a computing algorithm is used for correction of such temperature effects that may have been superimposed on the output pressure signal. This algorithm is based upon the relationship between membrane deflection, pressure and temperature. Correction data obtained experimentally may also be used as input data to the algorithm regarding temperature compensation.

### SUMMARY

The present disclosure relates to compensating, by means of a method and a device, for interference in intensity-based fiber-optical sensor systems, caused by intentional or unintentional bending of the optical fiber.

In one aspect, bending compensation in intensity-based optical measurement systems is disclosed, comprising a sensor element connected to a measuring and control unit via an optical connection and adapted for providing a signal corresponding to a measurement of a physical parameter in connection with the sensor element. This aspect comprises the generation of a measuring signal that is brought to come in towards the sensor element; the generation of a reference signal that is transmitted through the optical connection without being influenced in the sensor element, said measuring signal and said reference signal having different wavelengths; and the detection of said measuring signal and the detection of said reference signal. This aspect is characterised by comprising bending compensation through correction data based upon pre-stored data concerning the relationship between the measured reference signal and the measured measuring signal as a function of the bending influence on said optical connection.

A measuring system is disclosed for measuring a physical parameter influencing a sensor element adapted to be connected to a measuring and control unit. The system comprises an information-carrying unit comprising a memory and being adapted to be associated with said measuring and control unit, said information-carrying unit being coordinated with the sensor element by containing stored information regarding the properties of the measuring system and the sensor element during measurements, and said information-carrying unit being supported by a connector for connecting said sensor element with said measuring and control unit.

### BRIEF DESCRIPTION OF DRAWINGS

The invention will be explained in more detail below, with reference to a preferred embodiment and to the enclosed drawings, in which:

FIG. 1 shows, schematically, a pressure measuring system according to the present invention;

FIG. 1a shows an enlarged view of a sensor element intended for use in connection with the invention;

FIG. 2 shows a graph illustrating the relationship between a measured reference signal and a measured measuring signal as a function of the bending influence, in accordance with a method according to the invention;

FIG. 3 shows, in principle, a pressure measuring system in which a so-called “smart card” can be used as the information-carrying memory unit;

FIG. 4 shows, an exemplary embodiment in which a connector is associated with an information-carrying unit; and

FIG. 5 shows an alternative exemplary solution in which an information-carrying unit is constituted by a memory chip being arranged for cooperating with a detector unit in the form of a card reader.

### DETAILED DESCRIPTION

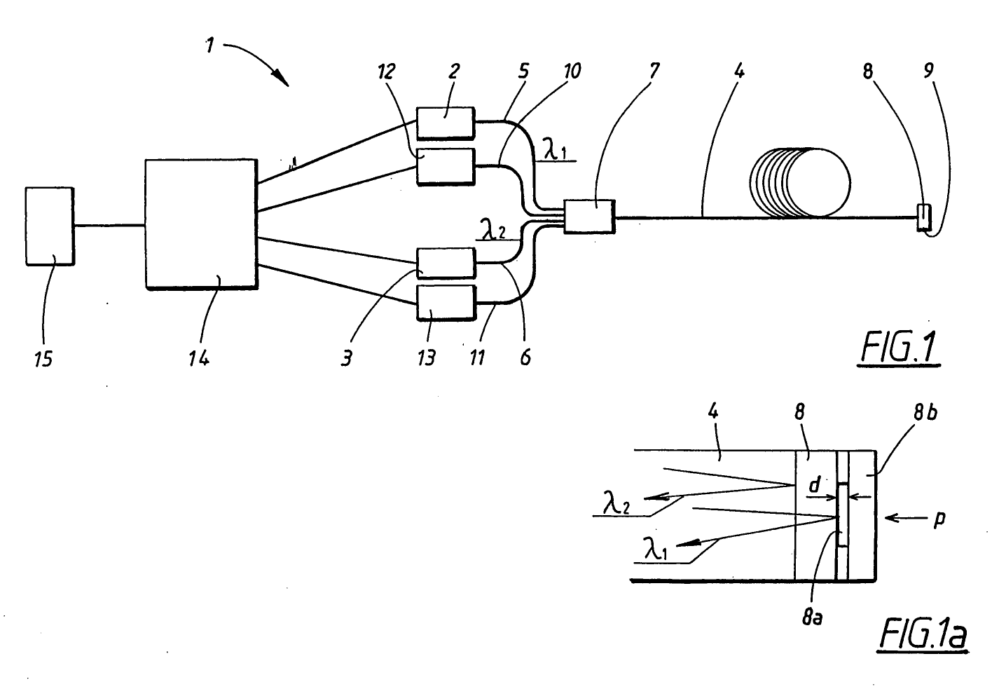

FIG. 1 shows, schematically, an intensity-based fiber-optical measuring system 1 according to the present invention. According to a preferred embodiment, the arrangement is used in connection with a fiber-optical measuring system of an as such previously known kind, which could preferably, but not exclusively, consist of a pressure measuring system. Alternatively, the invention could be used e.g. for measuring temperature and acceleration.

Two light sources belong to the system 1, comprising a first LED 2 and a second LED 3, the first LED 2 functioning to emit a first light signal of a first wavelength λ₁ and the second LED 3 functioning to emit a second light signal of a second wavelength λ₂, said wavelengths being different. The LED:s 2, 3 are connected to an optical conduit, preferably in the form of an as such previously known optical fiber 4, by means of a first link 5 and a second link 6, respectively, and also via a fiber coupling 7. The optical fiber 4 is connected to a sensor element 8, schematically illustrated in FIG. 1.

According to what is shown in detail by FIG. 1a, which is an enlarged view of the sensor element 8, said element comprises a cavity 8a, for example obtainable (according to known art) through construction by means of molecular layers (primarily silicone, alternatively silicone dioxide or a combination of the two) and an etching procedure. Preferably, a bonding procedure is also utilised in assembling the various layers of the sensor element 8. The manufacture of such a sensor element 8 is as such previously known, e.g. from the Patent Document PCT/SE93/00393. In this way, a membrane 8b is also created within the sensor element 8, the deflection of which membrane will depend on the pressure p surrounding the sensor element 8.

According to what will be described in detail below, the first light signal with the first wavelength λ₁ will come in and be reflected against the cavity 8a within the pressure sensor 8, whereas the second light signal with the second wavelength λ₂ is brought to come in onto the bottom side of the sensor element 8, i.e. towards the interface between the pressure sensor 8 and the optical fiber 4. Hereby, the first light signal will be modulated by the pressure p acting on the membrane 8b. When the membrane 8b is influenced, the dimensions of the cavity 8a, primarily its depth d, will change, entailing a modulation of the first light signal through optical interference inside the cavity 8a.

The second light signal will be reflected against the bottom side of the sensor element 8, due to the fact that the silicone defining the sensor element 8 will only allow transmission of light with a wavelength longer than a certain limit value (e.g. 900 nm). Consequently, said first wavelength λ₁ will be selected so as to exceed this limit value. Contrary to this, said second wavelength λ₂ will be selected so as to fall below this limit value. After having determined the two wavelengths λ₁, λ₂, appropriate dimensions of the cavity 8a are determined. For example, the depth of the cavity 8a is selected to be a value of substantially the same magnitude as the two wavelengths λ₁, λ₂. The sizing of the cavity 8a is made considering the required application range for the sensor element 8 (in the current case primarily the pressure range to which the sensor element 8 is to be adapted).

The light signal (λ₁) emitted from the first LED 2 defines a measuring signal that is thus transmitted through the fiber 4 to the sensor element 8, where said light signal will be modulated in the manner described above. The second light signal (λ₂) will then define a reference signal, transmitted through the fiber 4 and being reflected by the bottom side 9 of the sensor element 8. The light signal modulated in the sensor element 8 and the light signal reflected from the bottom side 9 of the sensor element are then transmitted back through the fiber 4. The returning light signals will, through the fiber coupling 7, be conveyed into fiber links 10, 11, connected to the detectors 12 and 13, respectively. The detectors 12, 13 will detect the measuring signal and the reference signal, respectively.

The four links 5, 6, 10, 11 preferably consist of optical fibers, the fiber coupling 7 thereby preferably consisting of an as such known fiber junction device designed so as to transfer the four fiber links 5, 6, 10, 11 into the fiber 4 leading to the sensor element 8.

The system 1 also comprises a computerised measuring and control unit 14, to which the LED:s 2, 3 and the detectors 12, 13 are connected. Said unit 14 comprises means for processing the values detected by said detectors 12, 13. According to the invention, the processing of the detected values includes a compensation for intentional or unintentional bending of the fiber 4, by, utilising correction data based upon pre-stored data concerning the relationship between a measured reference signal and a measured measuring signal as a function of the bending influence on the optical fiber 4. Such correction data could for example be comprised of a table or a function defining values to be used during measurements to correct the detected measuring signal.

Finally, the system 1 comprises a presentation unit 15, e.g. a display, allowing a measurement of the sensed pressure p to be visualised for a user.

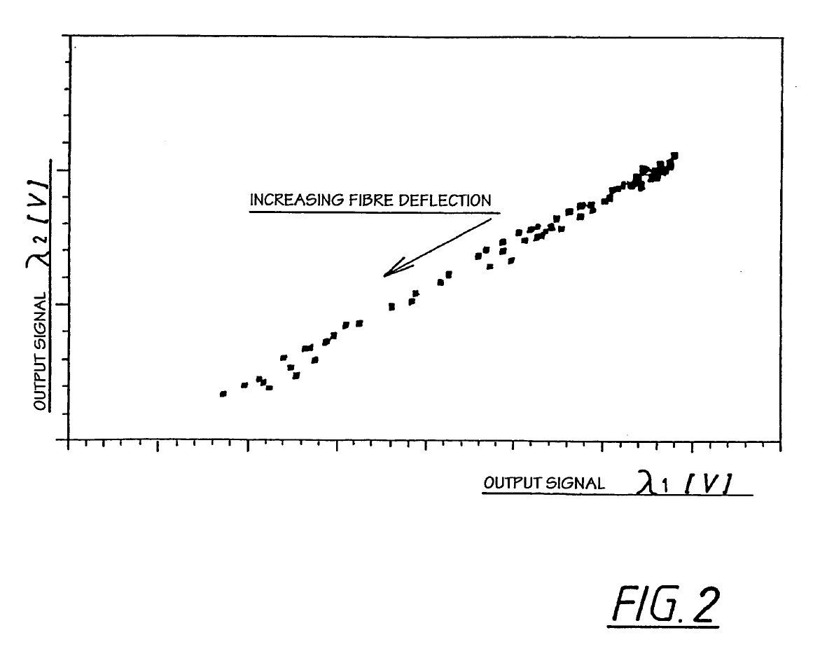

FIG. 2 graphically illustrates how the above relationship between a measured reference signal and a measured measuring signal is changed during increased bending of the fiber 4. In the figure, the reference signal is referenced as “Output signal λ₂ [V]” and the measuring signal as “Output signal λ₁[V]”. Said measured relationship can be described by a function, so as to correct the measuring signal continuously with a specific value depending on the reference signal. Alternatively, the measured relationship can be used for defining a mathematical function, which in turn is used for producing corrected values during measurements with the system according to the invention. As a further alternative, a number of measurement values may be registered in a table, into which the value of the reference signal is entered, to obtain a value (with the aid of interpolation, if necessary), with which the current measuring signal is corrected. Independently of the correction procedure used, it is performed in the above-mentioned measuring and control unit 14.

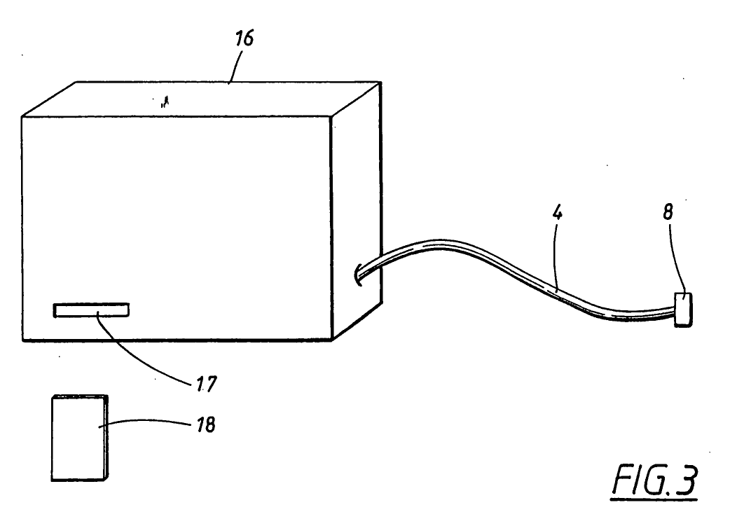

FIG. 3 shows, in principle, a pressure measuring system according to the invention, comprising an alternative measuring unit 16 to which the sensor element 8 is connected, via the optical fiber 4, in an exchangeable manner via an optical coupling (not shown in FIG. 3). Said measuring unit 16 also comprises a reader unit 17 for insertion and reading of a separate unit in the form of an information-carrying card 18 (also called “smart card”). Said card 18 comprises a memory device where data regarding the sensor element 8 are stored for use. During measurements, these data may be read by the measuring unit 16 and be used for example for bending compensation in dependence of which specific sensor element 8 that is being used for the moment. The invention thus provides a further advantage, in that different sensor elements 8 can be connected to said unit 16 without calibration, thanks to data stored on the information-carrying card 17. Said data preferably define the relationship between predetermined correction data, produced through measurements of the first as well as the second light signal at various degrees of bending of the optical fiber.

The invention is especially suitable in case a single measurement station with one measuring unit 16 is used together with several exchangeable sensor elements. In such a case, data corresponding to properties, measuring range, etc. of each sensor element, can be stored on a corresponding number of information carrying cards, each then corresponding to (and being used together with) a specific sensor element.

As an alternative to an information-carrying unit in the form of a card, the invention can also be used with other types of separate data carriers. Further, the measuring system according to FIG. 3, as opposed to what is shown in FIGS. 1 and 2, is not limited to measurements of the kind using two different wavelengths, but can also be used when measuring with for example only one wavelength.

It should be mentioned, that the card 18 may also contain other stored information than that mentioned above, e.g. information regarding the sensor type, calibration data, etc. The basic principle is, however, that the card 18 is coordinated with a specific sensor element such that it will comprise stored data regarding the function of the specific sensor element Preferably, the card 18 will be provided with information—in the form of a set of parameters—allowing the properties of the sensor element 8, together with the properties of the measuring unit 16, to provide a suitable linerisation of the characteristics of the specific sensor element during measurements.

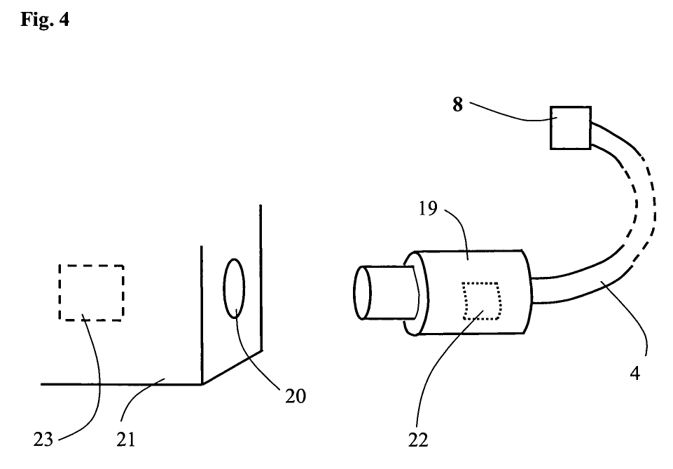

According to a further embodiment of the invention, which will now be described with reference to FIG. 4, the sensor element 8 and the optical fiber 4 are associated with a connector 19. The sensor element 8 is arranged at one end of the optical fiber 4 and the connector 19 is arranged at the opposite end of the optical fiber 4.

The connector 19 as shown in FIG. 4 is formed in a manner (suitably as a conventional plug) so as to cooperate with a socket 20 by inserting it into the socket 20. To this end, the connector 19 is formed so as to fit into the socket 20 in order to transmit signals between the sensor element 8 and the measuring and control unit 21.

According to the embodiment shown in FIG. 4, the connector 19 is associated with an information-carrying unit 22 which is supported by, and suitably physically integrated with, the connector 19. According to the embodiment, the information-carrying unit 22 is in the form of a RFID tag (Radio Frequency Identification tag), which is a previously known type of microchip circuit which is combined with an antenna so as to form a single unit. The information-carrying unit 22 is designed to be physically integrated with the connector 19, suitably in a manner wherein it is embedded into the connector 19.

Generally, a RFID tag is previously known as such, and for this reason it is not described in greater detail here. However, it should be mentioned that the information-carrying unit 22 has an antenna (not shown) which cooperates with a detector unit 23 in the form of an RFID reader 23 which is provided in the measuring and control unit 21. More precisely, the RFID reader 23 is arranged for transmitting signals to be picked up by the information-carrying unit 22, which returns the signal, suitably with additional data included in the returned signal. Such additional data can suitably be in the form of stored information related to the sensor element 8, i.e. data relating to the type of sensor element used, and data related to bending compensation corresponding to that which has been explained above. Also, such stored data may comprise calibration data and other data related to the function of the sensor element 8. Consequently, the information-carrying unit 22 operates as a memory unit which stores data to be fed to the measuring and control unit 21 through operation of the RFID reader 23.

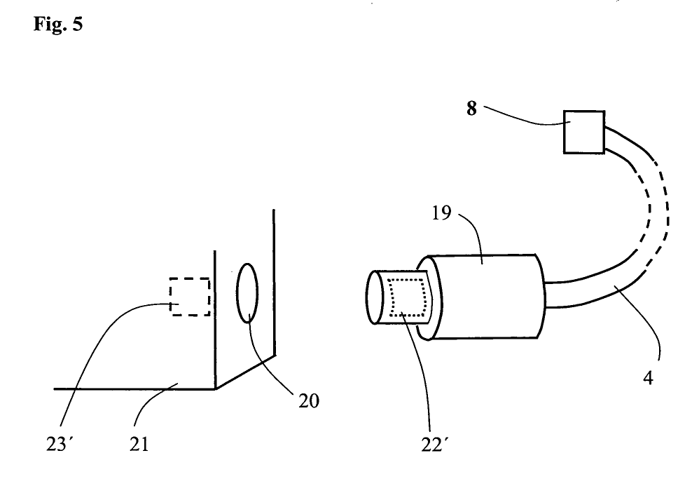

According to an alternative solution, shown in FIG. 5, the information-carrying unit 22′ is constituted by a memory chip being arranged for cooperating with a detector unit 23′ in the form of a card reader. This embodiment is consequently of generally the same type as a conventional contact smart card being used as a credit card or being used as mobile telephone SIM cards. This means that according to this embodiment, the connection between the information-carrying unit 22′ and the card reader 23′ is not wireless but is based on a mechanical contact between contact pads (not shown) in the information-carrying unit 22′ and corresponding contact surfaces in the card reader 23′.

Accordingly, the exemplary embodiments described with reference to FIGS. 4 and 5 are generally based on a device for connecting the sensor element to a measuring and control unit, said device suitably being in the form of a connector 19 to be connected with a socket 20 formed in the measuring and control unit 21. The connector 19 carries an information-carrying unit 22 (22′). The transmission of information between the information-carrying unit can be wireless, as explained with reference to FIG. 4, or through physical contact, as explained with reference to FIG. 5.

In a manner which corresponds to the embodiment shown in FIG. 3, the embodiments shown in FIGS. 4 and 5 also comprise a measuring unit 21 which is arranged to read data stored in the information-carrying unit 22 (22′) so as to be used, for example, for bending compensation during measurements, depending on which sensor element 8 is used for the moment.

Alternatively, the embodiments shown in FIGS. 4 and 5 are also useful in a situation in which a measuring unit 21 is used together with a number of different sensor elements. In such a case, various data corresponding to the properties of each specific sensor element can be stored in an information-carrying unit like the one shown in FIGS. 4 and 5. In this manner, each sensor element is associated with an information-carrying unit, physically integrated into the connector which is connected to the sensor element and being provided with stored information which in a unique manner represents the properties of the corresponding sensor element.

The invention is not limited to the embodiment described above, but may be varied within the scope of the appended claims. For example, the principle for data storage regarding a specific sensor on a separate information-carrying card can be used also for systems not intended for pressure measurements.

What is claimed is:

1. A measuring system for measuring a physical parameter influencing a sensor element adapted to be connected to a measuring and control unit, wherein said system comprises an information-carrying unit comprising a memory and being adapted to be associated with said measuring and control unit, said information-carrying unit being coordinated with the sensor element by containing stored information regarding the properties of the measuring system and the sensor element during measurements, and said information-carrying unit being supported by a connector for connecting said sensor element with said measuring and control unit.

2. The measuring system according to claim 1, wherein said sensor element is connected to said measuring and control unit via a connector adapted for cooperating with a socket being part of said measuring and control unit and wherein said information-carrying unit is physically integrated with said connector.

3. The measuring system according to claim 2, wherein said information-carrying unit is constituted by an RFID tag cooperating in a wireless manner with an RFID reader forming part of said measuring and control unit.

4. The measuring system according to claim 2, wherein said information-carrying unit is constituted by a memory chip cooperating with a reader unit forming part of said measuring and control unit.

5. The measuring system according to claim 1, wherein said connector which connects said sensor element to said measuring and control unit is an optical connection, wherein said stored information includes pre-defined correction data concerning the relationship between the measured reference signal and the measured signal as a function of the bending influence upon said optical connection, or calibration data for said sensor element.

6. The measuring system according to claim 2, wherein said connector which connects said sensor element to said measuring and control unit is an optical connection, wherein said stored information includes pre-defined correction data concerning the relationship between the measured reference signal and the measured signal as a function of the bending influence upon said optical connection, or calibration data for said sensor element.

7. The measuring system according to claim 3, wherein said connector which connects said sensor element to said measuring and control unit is an optical connection, wherein said stored information includes pre-defined correction data concerning the relationship between the measured reference signal and the measured signal as a function of the bending influence upon said optical connection, or calibration data for said sensor element.

8. The measuring system according to claim 4, wherein said connector which connects said sensor element to said measuring and control unit is an optical connection, wherein said stored information includes pre-defined correction data concerning the relationship between the measured reference signal and the measured signal as a function of the bending influence upon said optical connection, or calibration data for said sensor element.

9. The measuring system according to claim 5, wherein said connector and said sensor element are mounted to the opposing ends of an optical fiber.
